(19) United States
(12) Patent Application Publication
(10) Pub. No.: US 2026/0106204 A1
(43) Pub. Date: Apr. 16, 2026

(54) DEVIATION CORRECTION APPARATUS AND METHOD OF CORRECTING DEVIATION BY USING THE SAME

(71) Applicant: SAMSUNG SDI CO., LTD., Yongin-si (KR)

(72) Inventors: Sanghyun YOO, Yongin-si, Gyeonggi-do (KR); Junsub LEE, Yongin-si, Gyeonggi-do (KR)

(21) Appl. No.: 19/270,691

(22) Filed: Jul. 16, 2025

(30) Foreign Application Priority Data
Oct. 16, 2024 (KR) 10-2024-0140982

(51) Int. Cl. H01M 10/04; H01M 4/04

(52) U.S. Cl. CPC H01M 10/045; H01M 4/0435; H01M 4/0471

(57) ABSTRACT

The present disclosure provides a deviation correction system and a method of correcting a deviation by using the same. A deviation correction apparatus may include a heater for heating an electrode plate of a secondary battery having an active material layer on a current collector, a spiral roller having a spiral protrusion, and a base roller facing and spaced apart from the spiral roller. The spiral roller and the base roller may be configured so that the electrode plate may be inserted between and may be moved between the spiral roller and the base roller.

### CROSS-REFERENCE TO RELATED APPLICATION

The present application claims priority to and the benefit of Korean Application No. 10-2024-0140982, filed on October 16, 2024, in the Korean Intellectual Property Office, the entire disclosure being incorporated by reference herein.

### BACKGROUND TECHNICAL FIELD

The present disclosure relates to a deviation correction apparatus and a method of correcting a deviation by using the same.

### DESCRIPTION OF THE RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, laptop computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A process of manufacturing such secondary batteries is largely divided into three stages: a process of manufacturing electrodes, a process of manufacturing electrode assemblies, and a formation process. A process of manufacturing electrodes can be subdivided into a process of mixing electrode mixtures, a process of coating and drying electrodes, a rolling process, a slitting process, a winding process, etc.

The process of mixing electrode mixtures includes a process of mixing components for forming an electrode active layer where an electrochemical reaction occurs on an electrode by mixing an electrode active material, which is an essential component of an electrode, and other additives such as a conductive material, a filler, a binder for bonding powders and for adhesion to a current collector, and a solvent for imparting viscosity and dispersing powders into the form of slurry having fluidity. A composition mixed in such a manner is also broadly referred to as an electrode mixture.

The process of coating and drying electrodes is a process of applying an electrode mixture onto a current collector, which is electrically conductive, and removing a solvent contained in slurry.

Then, in the rolling process, the electrode mixture and the current collector are fixed by reel pressing, or by other methods.

During the reel press rolling, a difference in elongation occurs due to the difference in stress between a coated portion having the electrode mixture and a non-coated portion not having the electrode mixture. Such a difference in elongation may result in a deviation in which an electrode plate (which is severed in a movement direction of the electrode plate) is bent during a half-slitting process of the slitting process of cutting the electrode plate in half. Because a cell defect rate may increase during the process of winding or stacking electrodes due to the deviation, it is necessary to develop a method of manufacturing a secondary battery in which such a deviation can be corrected.

The above information disclosed in this Background section is for enhancement of understanding of the background of the present disclosure, and therefore, it may contain information that does not constitute related (or prior) art.

### SUMMARY

The present disclosure has been made in an effort to provide a deviation correction system and a method of correcting a deviation by the same for the purpose of solving the above-mentioned technical problems.

These and other aspects and features of the present disclosure will be described in or will be apparent from the following description of embodiments of the present disclosure.

According to some embodiments of the present disclosure a deviation correction apparatus may include a heater for heating an electrode plate of a secondary battery having an active material layer on a current collector, a spiral roller having a spiral protrusion, and a base roller facing and spaced apart from the spiral roller. The spiral roller and the base roller may be configured so that the electrode plate is inserted between the spiral roller and the base roller and is moved between the spiral roller and the base roller.

In some embodiments, the deviation correction apparatus further includes a half-slitter configured to sever the electrode plate in a direction in which the plate moves.

In some embodiments, a direction in which the spiral protrusion of the spiral roller advances may be perpendicular to a direction in which the electrode plate moves.

In some embodiments, a height of the spiral protrusion may be 1.5 mm to 2.5 mm, and a width of the spiral protrusion may be 10 mm to 14 mm.

In some embodiments, the spiral protrusion may include protrusions spaced apart from each other in an axial direction, and a distance between the protrusions spaced apart from each other in the axial direction is from 8 mm to 12 mm.

In some embodiments, the spiral protrusion may include a coating layer, and a thickness of the coating layer may be 40 µm to 60 µm.

In some embodiments, the spiral protrusion may include the coating layer, and the coating layer may contain ethylene-propylene diene monomer (EPDM).

In some embodiments, the spiral roller may include a first spiral roller and a second spiral roller, and a protrusion of the first spiral roller and a protrusion of the second spiral roller may be configured to advance in opposite directions.

In some embodiments, the deviation correction apparatus may further include a driver configured to provide a rotational force to the spiral roller and a clutch configured to send the rotational force provided by the driver to the spiral roller.

In some embodiments, the clutch may include a powder clutch.

In some embodiments, the heater may include a near-infrared (NIR) lamp.

In some embodiments, the deviation correction apparatus may further include a driver configured to provide a rotational force to the spiral roller, a deviation sensing sensor configured to measure a level of deviation of the electrode plate, and a controller configured to receive a signal from the deviation sensing sensor and configured to control the driver.

In some embodiments, the deviation correction apparatus may further include a rewinding roller configured to wind the electrode plate.

In some embodiments, a rotation of the base roller may be linked to a rotation of the rewinding roller.

In some embodiments, a rotation of the spiral roller may have a torque different than the torque of a rotation of the base roller.

According to some embodiments of the present disclosure, a method of correcting a deviation may include heating an electrode plate of a secondary battery having an active material layer on a current collector, inserting an electrode plate between a spiral roller having a spiral protrusion and a base roller facing and spaced apart from the spiral roller, moving the electrode plate between the spiral roller and the base roller, and rotating the spiral roller and the base roller to correct a deviation of the electrode plate.

In some embodiments, the method of correcting the deviation may further include severing the electrode plate in a direction in which the electrode plate moves by a half-slitter before heating the electrode plate of the secondary battery.

In some embodiments, the electrode plate may include a first electrode plate and a second electrode plate, the spiral roller may include a first spiral roller and a second spiral roller, and a protrusion of the first spiral roller and a protrusion of the second spiral roller may advance in opposite directions, and the method of correcting the deviation may further include correcting the first electrode plate and the second electrode plate in opposite directions.

In some embodiments, the method of correcting the deviation may further include controlling, via a controller, a driver so that the driver provides a rotational.

In some embodiments, a rotation of the base roller may be linked to a rotation of a rewinding roller winding the electrode plate, and the method of correcting the deviation further includes winding the electrode plate via the rewinding roller.

According to some embodiments, it may be possible to minimize deviations caused by a difference in stresses on electrode plates in a rolling process and to lower a cell defect rate in a process of winding or stacking electrodes.

According to some embodiments, an optimized shape of a spiral roller of a deviation correction apparatus for applying stress in a direction opposite to a deviation may be provided.

Some apparatuses and methods of the present disclosure may effectively and quickly provide electrodes for secondary batteries of a uniform quality by re-stretching an electrode plate in a direction opposite a deviation created on the electrode plate after heating.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic view of a deviation correction system according to some embodiments of the present disclosure.

FIG. 2 shows a heater according to some embodiments of the present disclosure.

FIG. 3 shows a spiral roller of a deviation correction system and a periphery of the spiral roller according to some embodiments of the present disclosure.

FIG. 4 shows a shape of a spiral roller according to some embodiments of the present disclosure.

FIG. 5 is a schematic view of a rolling process of manufacturing an electrode plate provided to a deviation correction system according to some embodiments of the present disclosure.

FIG. 6 shows an electrode plate that has passed through a half-slitter of a deviation correction system according to some embodiments of the present disclosure.

FIG. 7 is a plan view of a deviation correction system according to some embodiments of the present disclosure.

FIG. 8 is a flowchart of a method of correcting a deviation according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

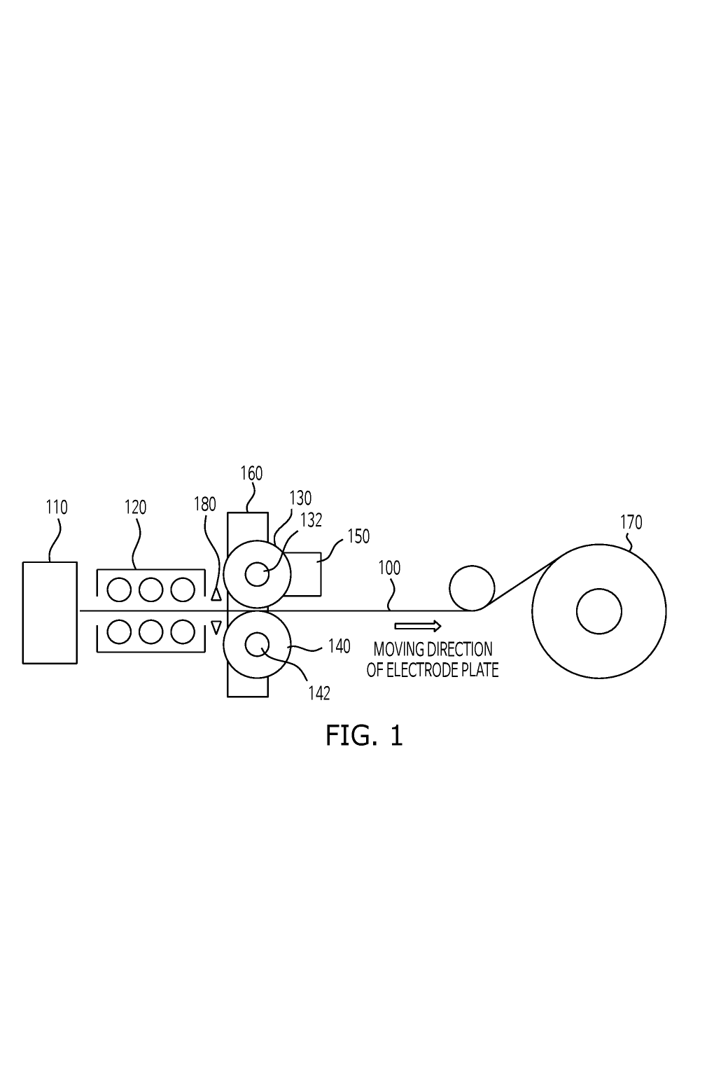

FIG. 1 is a schematic view of a deviation correction system according to some embodiments of the present disclosure.

Referring to FIG. 1, a deviation correction apparatus may include a heater 120 for heating an electrode plate 100 of a secondary battery, a spiral roller 130 including a spiral protrusion, and a base roller 140 facing and spaced apart from the spiral roller 130. The electrode plate 100 may pass through the heater 120, may be inserted and carried between the spiral roller 130 and the base roller 140, and may be wound by a rewinding roller 170.

The electrode plate 100 of the secondary battery may include an active material layer applied on a current collector. The composition of the active material layer may vary depending on the type of electrode to be manufactured. For example, when the electrode to be manufactured is a positive electrode, the active material may be a positive electrode active material, and, when the electrode to be manufactured is a negative electrode, the active material may be a negative electrode active material.

The current collector is not particularly limited as long as it has high conductivity without causing chemical changes. For example, the current collector may include copper, aluminum, stainless steel, nickel, titanium, calcined carbon, or any combination thereof. The current collector may be formed as a metal foil or a thin metal plate, such as copper, a copper alloy, nickel, or a nickel alloy. In some embodiments, the current collector may be formed as a metal foil or a thin metal plate, such as aluminum or an aluminum alloy.

The electrode plate 100 of the secondary battery may include a current collector in the form of a thin metal plate and an active material layer formed by applying an active material to both sides or one side of the current collector. The electrode plate 100 may include (i) a coated portion where there is an active material layer and (ii) a non-coated portion where there is no active material layer and where the current collector or substrate is exposed. For example, the electrode plate 100 may be formed as a positive electrode of a secondary battery by coating an aluminum (Al) substrate with a positive electrode active material. As another example, the electrode plate 100 may be formed as a negative electrode of a secondary battery by coating a copper (Cu) substrate with a negative electrode active material.

The material of the active material layer may be an amorphous mixture in a form of powder or a lump of powder. In some embodiments, the active material layer may include a mixture of an active material or an electrode active material, a conductive material, and a binder. The mixture is not limited as long as it is a wet or dry mixture of an active material, a conductive material, and a binder, and the mixture can be formed in various ways.

The electrode plate 100 may be inserted and moved between the spiral roller 130 and the base roller 140. In some embodiments, in order to efficiently move and process the electrode plate 100 during the process of manufacturing a secondary battery, the electrode plate 100 may be inserted between a spiral roller 130 having a spiral protrusion on the surface and a base roller 140 that is spaced apart from and is facing the spiral roller 130 by a certain distance and provides a frictional force and pressure to the electrode plate.

A rotation axis 132 of the spiral roller 130 and a rotation axis 142 of the base roller 140 may be parallel to each other. The direction of the rotation axis 132 of the spiral roller 130 and the rotation axis 142 of the base roller 140, which are parallel to each other, may be perpendicular to a direction in which the electrode plate 100 moves. As a result, the spiral roller 130 and the base roller 140 may apply force to the electrode plate 100 in a constant direction.

The rotation axis 132 of the spiral roller 130 may rotate by receiving force from a driver 150. In contrast, the base roller 140 may rotate separately from the driver 150 and the spiral roller 130 so that the rotation of the spiral roller 130 and the rotation of the base roller 140 may have different torques.

The deviation correction apparatus may further include a deviation sensing sensor 180 configured to measure the level of deviation of the electrode plate 100. The deviation sensing sensor 180 is not particularly limited as long as it can measure the level of deviation of the electrode plate 100 to upgrade the process of producing a secondary battery. For example, the deviation sensing sensor 180 may include an optical sensor including a camera system or a photosensor, an ultrasonic sensor using ultrasonic signals, a laser sensor including a laser rangefinder, a magnetic sensor, and any combination thereof.

The deviation correction apparatus may further include a controller 160 configured to receive a signal from the deviation sensing sensor 180 and controls the driver 150. As feedback for the signal, the controller 160 may transmit a control signal that determines a direction in which the driver 150 providing a rotational force to the spiral roller 130 rotates, the speed of the driver 150, and whether the driver 150 will rotate. A transmission of the signal of the deviation sensing sensor 180 and a transmission of the feedback of the controller 160 may be repeated in real time.

The deviation correction apparatus may further include the rewinding roller 170 for winding the electrode plate 100. In some embodiments, the rotation of the base roller 140 may be linked to the rotation of the rewinding roller 170. In some embodiments, a value obtained by multiplying the speed at which the base roller 140 rotates by the outer diameter of the base roller 140 may be equal to a value obtained by multiplying the speed at which the rewinding roller 170 rotates by the outer diameter of the rewinding roller 170. Accordingly, the speed at which the rewinding roller 170 winds the electrode plate 100 may be equal to the speed at which the base roller 140 moves the electrode plate 100 by friction between the surface of the base roller 140 and the electrode plate 100 so that tension may not be added to the electrode plate 100.

The deviation correction system may further include a half-slitter 110 that severs the electrode plate 100 in the direction in which the electrode plate 100 moves. For example, the half-slitter 110 may include a severing roller that cuts the electrode plate 100 in a direction parallel to the direction in which the electrode plate 100 moves, a pressure roller that stably holds the electrode plate together with the severing roller and applies pressure thereto, a guide that allows the electrode plate 100 to be inserted between the severing roller and the pressure roller, and a motor that drives the severing roller and the pressure roller.

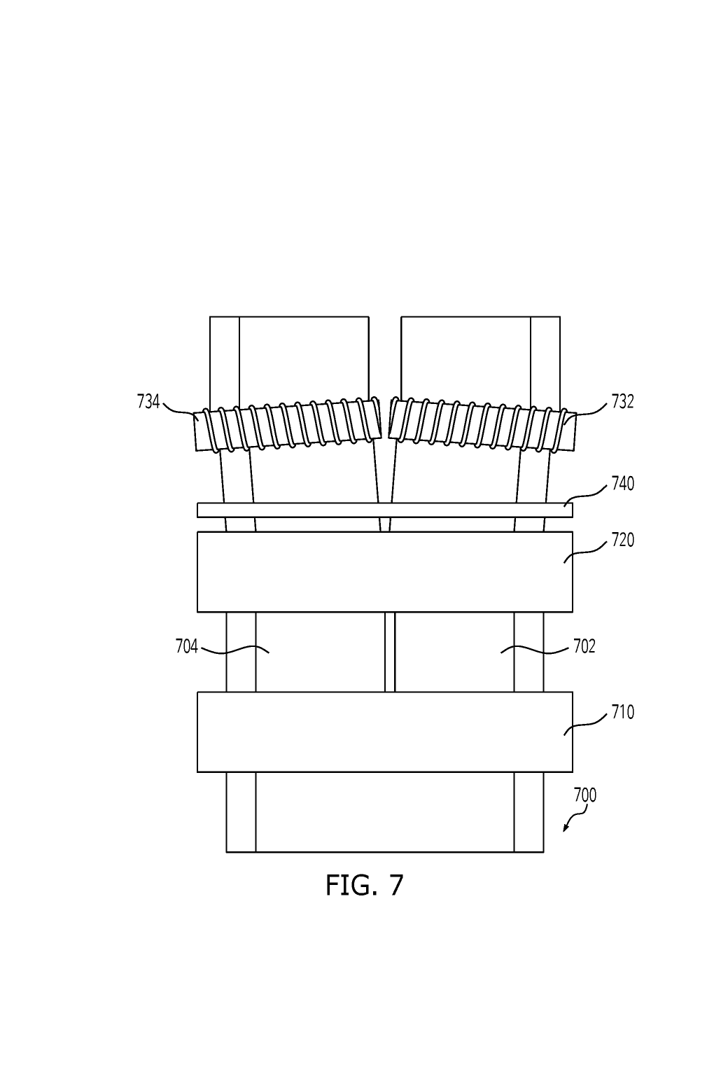

The half-slitter 110 may be positioned before the heater 120 for heating the electrode plate 100. Therefore, while passing through the deviation correction system, after the electrode plate 100 is cut in the direction in which it moves and divided into a first electrode plate and a second electrode plate, it may be heated by the heater 120. In some embodiments, the width of the first electrode plate may be equal to the width of the second electrode plate. This will be described below with reference to FIG. 7.

The deviation correction apparatus may effectively and quickly provide electrodes for secondary batteries of a uniform quality by re-stretching the electrode plate 100 in a direction opposite the deviation created on the electrode plate 100 after heating.

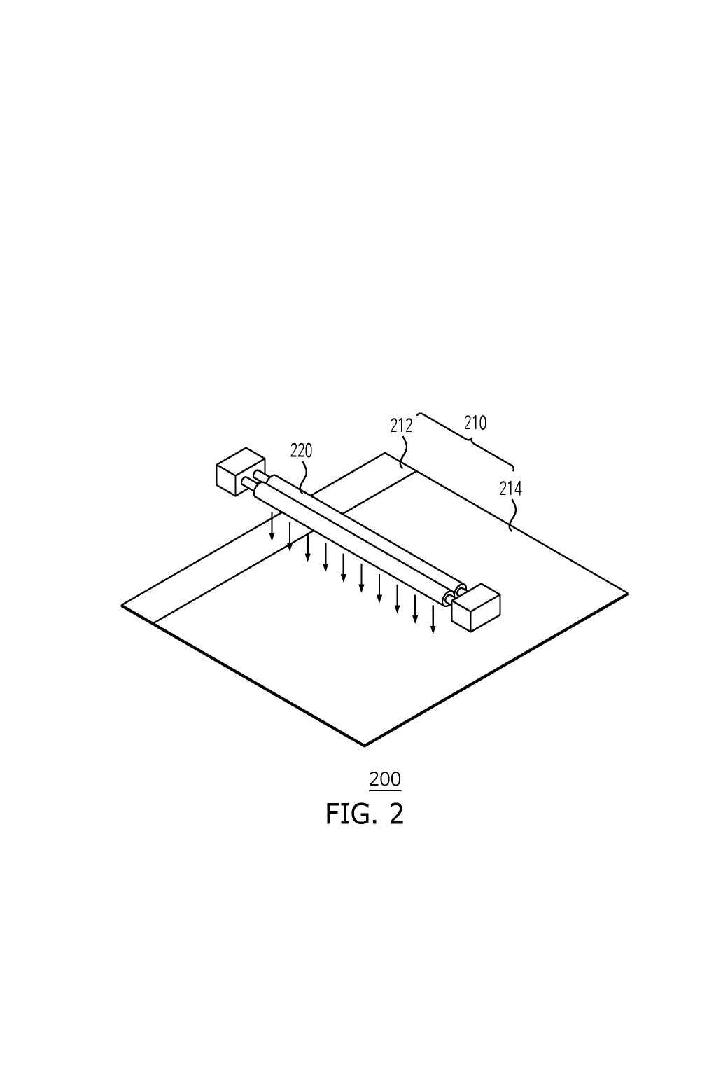

FIG. 2 shows a heater according to some embodiments of the present disclosure.

Referring to FIG. 2, a heater 200 according to some embodiments of the present disclosure may transfer heat to an electrode plate 210 to increase flexibility thereof before the electrode plate 210 with deviation is inserted between a spiral roller and a base roller. The electrode plate 210 may be heated to a temperature of 80 °C to 250 °C while passing through the heater 200.

The heater 200 may transfer heat uniformly to a non-coated portion 212 and an active material layer 214 of the electrode plate 210. For example, the heater 200 may be arranged parallel to a direction in which the electrode plate 210 moves, and the vertical distance between each point of the heater 200 and the electrode plate 210 may be constant.

The heater 200 according to some embodiments may include a near-infrared (NIR) lamp 220. The NIR lamp 220 may heat the electrode plate 210 by emitting near-infrared wavelengths. When heat is transferred through near-infrared wavelengths, a faster response speed and a higher energy efficiency may be achieved compared to other methods.

Although not shown, the heater 200 may include a housing that protects the NIR lamp 220, a temperature sensor that monitors the temperature of the electrode plate in real time to prevent overheating or melting of the electrode plate 210, a cooling system to prevent overheating of the electrode plate 210, a control system that controls the output and temperature of the NIR lamp 220 using a signal transmitted from the temperature sensor, or any combination thereof.

The heater 200 may include various features for heating the electrode plate 210 in addition to the NIR lamp 220. For example, the heater 200 may include an electric heater, a hot air heater, a microwave heater, etc. How the electrode plate is heated by the heater 200 is not limited to features and methods discussed in the present disclosure, and a range of features and methods may be mixed.

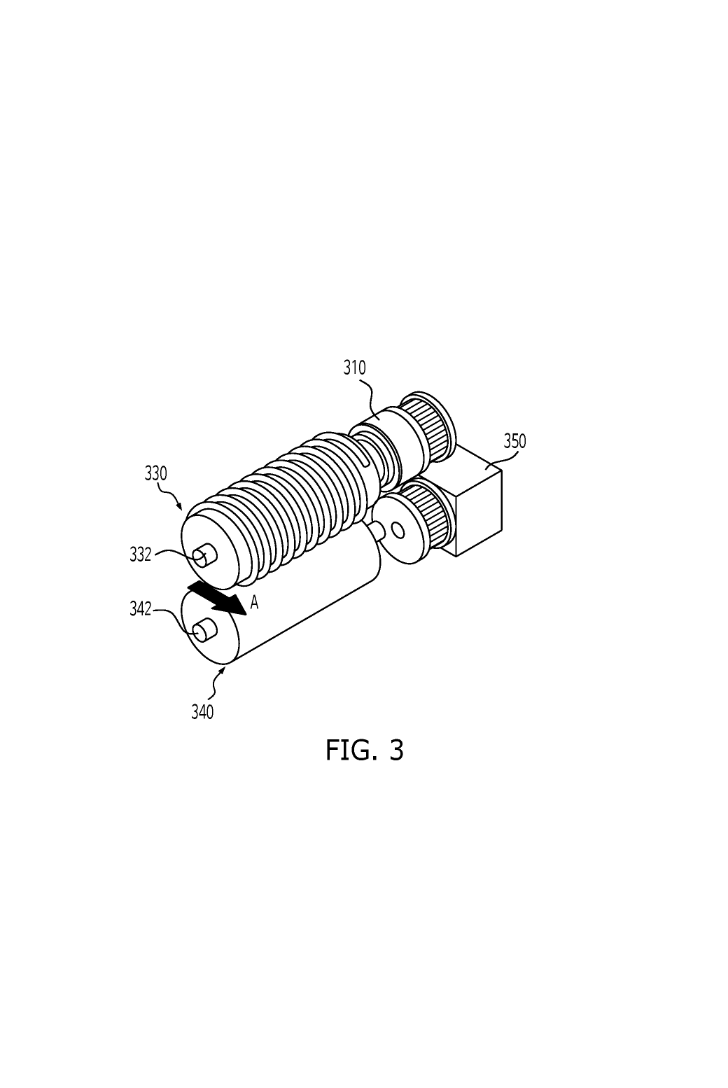

FIG. 3 shows a spiral roller of a deviation correction system and a periphery of the spiral roller according to some embodiments of the present disclosure.

A deviation correction apparatus according to some embodiments of the present disclosure may further include a driver 350 configured to provide a rotational force to a spiral roller 330 and a clutch 310 for carrying the rotational force provided by the driver 350 to the spiral roller 330.

The driver 350 may include a direct current motor (DC motor), an alternating current motor (AC motor), an electric motor including a servo motor, or any combination thereof to provide a rotational force to the spiral roller 330. In some embodiments, the driver 350 includes a servo motor that can be precisely controlled.

The driver 350 may include a gear box for lowering or increasing the speed to convert a rotational force of a motor into an appropriate speed and torque.

The clutch 310 may send the rotational force provided by the driver 350 to the spiral roller 330 or stop it from getting through thereto. As a result, the operation of the spiral roller 330 may be stopped or restarted as needed. The clutch 310 may be placed between the driver 350 and the spiral roller 330 and may be directly connected to a rotation axis 332 of the spiral roller 330. For example, the clutch 310 may include a friction clutch or a friction clutch including a centrifugal clutch. As another example, the clutch 310 may include an electronic clutch configured to send or to block a rotational force using an electromagnetic force. As a further example, the clutch 310 may include a hydraulic clutch or a powder clutch.

The driver 350 may generate a rotational force in response to a signal transmitted by a controller (not shown) such as the controller 160 in FIG. 1. The generated rotational force may be sent to the rotation axis 332 of the spiral roller 330 through the clutch 310, resulting in the rotation of the spiral roller 330 in a precise manner. The spiral roller 330 may move an electrode plate while rotating and may correct a deviation on the electrode plate while a spiral protrusion on the surface of the spiral roller 330 moves the electrode plate. A deviation sensing sensor (not shown) such as the deviation sensing sensor 180 in FIG. 1 may monitor the position and the level of deviation of the electrode plate in real time to adjust the driver 350 or the clutch 310.

The rotation axis 332 of the spiral roller 330 and a rotation axis 342 of a base roller 340 may be parallel to each other. A direction of the rotation axis 332 of the spiral roller 330 and a direction of the rotation axis 342 of the base roller 340, which are parallel to each other, may be perpendicular to a direction A in which the electrode plate moves. Accordingly, the spiral roller 330 and the base roller 340 facing and spaced apart from the spiral roller 330 may uniformly apply force to the electrode plate in a constant direction.

The rotation of the spiral roller 330 and the rotation of the base roller 340 may have different torques. In some embodiments, the rotation axis 332 of the spiral roller 330 may rotate by receiving force from the driver 350, while the base roller 340 may be passively rotated by the movement of the electrode plate separately from the driver 350 and the spiral roller 330.

The rotation of the base roller 340 may be linked to the rotation of a rewinding roller. The electrode plate may move by the rotation of the rewinding roller, and the base roller 340 may rotate by a frictional force resulting from the movement of the electrode plate. Further, a separate power source for supplying power may not be connected to the rotation axis 342 of the base roller 340.

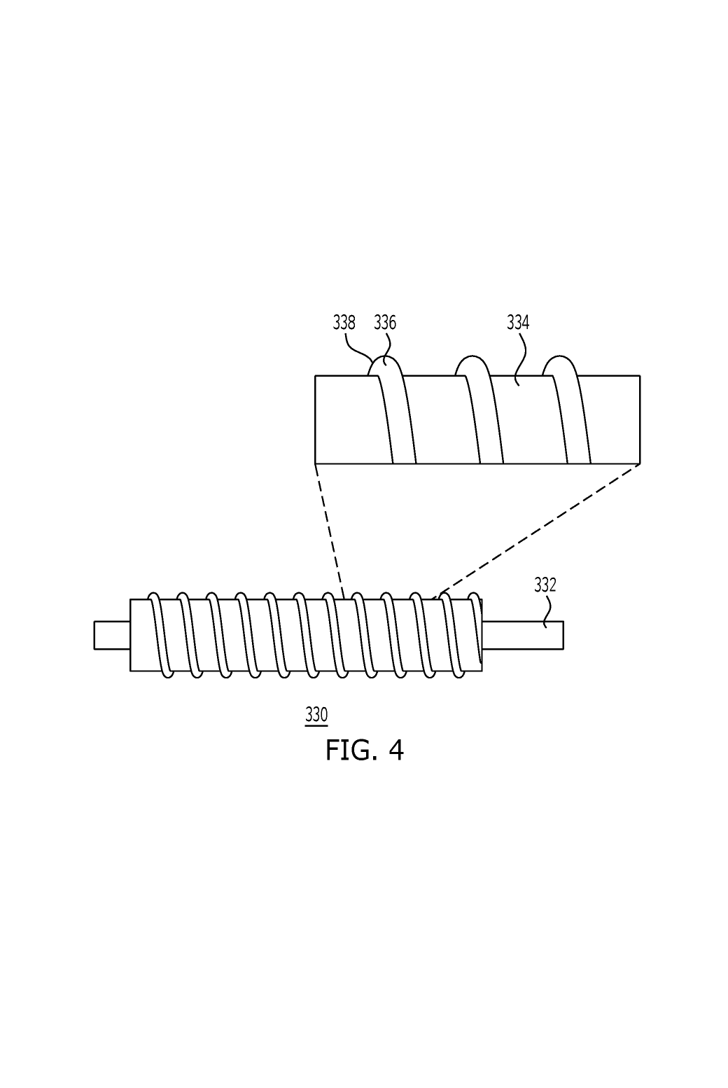

FIG. 4 shows a shape of a spiral roller according to some embodiments of the present disclosure.

Referring to FIG. 4, a direction in which a spiral protrusion 336 of the spiral roller 330 according to some embodiments of the present disclosure advances may be perpendicular to the direction in which the electrode plate moves. In some embodiments, the protrusion 336 of the spiral roller 330 may be spirally wrapped around a roller 334 of the spiral roller 330. Therefore, the direction in which the spiral protrusion 336 of the spiral roller 330 advances may be parallel to the rotation axis 332 of the spiral roller 330. In order to evenly correct a deviation on the electrode plate, the rotation axis 332 of the spiral roller 330 and the direction in which the spiral protrusion 336 of the spiral roller 330 advances may be perpendicular to the direction in which the electrode plate moves. For example, as shown in FIG. 4, the protrusion 336 of the spiral roller 330 may move to the right while being wound around the roller 334 of the spiral roller 330 in a clockwise direction when viewed from the left. In another embodiment, as shown in FIG. 4, the protrusion 336 of the spiral roller 330 may move to the right while being wound around the roller 334 of the spiral roller 330 in a counterclockwise direction when viewed from the left.

A height of the protrusion 336 protruding from the roller 334 of the spiral roller 330 may be from 1.5 mm to 2.5 mm. In some embodiments, a width of the protrusion 336 may be from 10 mm to 14 mm.

A distance between the protrusions 336 spaced apart from each other in the direction of the rotation axis 332 of the spiral roller 330 may be from 8 mm to 12 mm. In some embodiments, a distance between the nth spirally wound protrusion 336 and the n+1th spirally wound protrusion 336 may be from 8 mm to 12 mm (where n is a natural number).

The protrusion 336 of the spiral roller 330 may include a coating layer 338, and a thickness of the coating layer 338 may be from 40 μm to 60 μm. The coating layer 338 may serve to improve the durability of the spiral roller 330, optimize friction with the electrode plate, and maintain a performance of the spiral roller 330. In some embodiments, the coating material of the coating layer 338 is not limited to the features discussed in the present disclosure as long as it has properties such as durability, wear resistance, low friction, and heat resistance sufficient to perform a method of the present disclosure. For example, the coating layer 338 may include polyurethane, polytetrafluoroethylene (PTFE), silicone rubber, nitrile rubber (NBR), polyethylene, epoxy coating, chromium plating, carbide coating, ethylene-propylene diene monomer (EPDM), or any combination thereof. It may be desirable that the coating layer 338 includes EPDM, which may be inexpensive and which has excellent chemical resistance, flexibility, and heat resistance.

The roller 334 of the spiral roller 330 may have a cylindrical shape. In some embodiments, a diameter of the roller 334 may be from 90 mm to 110 mm. In some embodiments, a width of the roller 334 may be from 400 mm to 500 mm. A size of the roller 334 of the spiral roller 330 may vary depending on a size of an electrode plate. In some embodiments, a size of the protrusion 336 formed on the roller 334 of the spiral roller 330 may also vary depending on the size of the electrode plate.

An optimized shape of the spiral roller 330 of the deviation correction apparatus for applying stress in a direction opposite to a deviation may be provided.

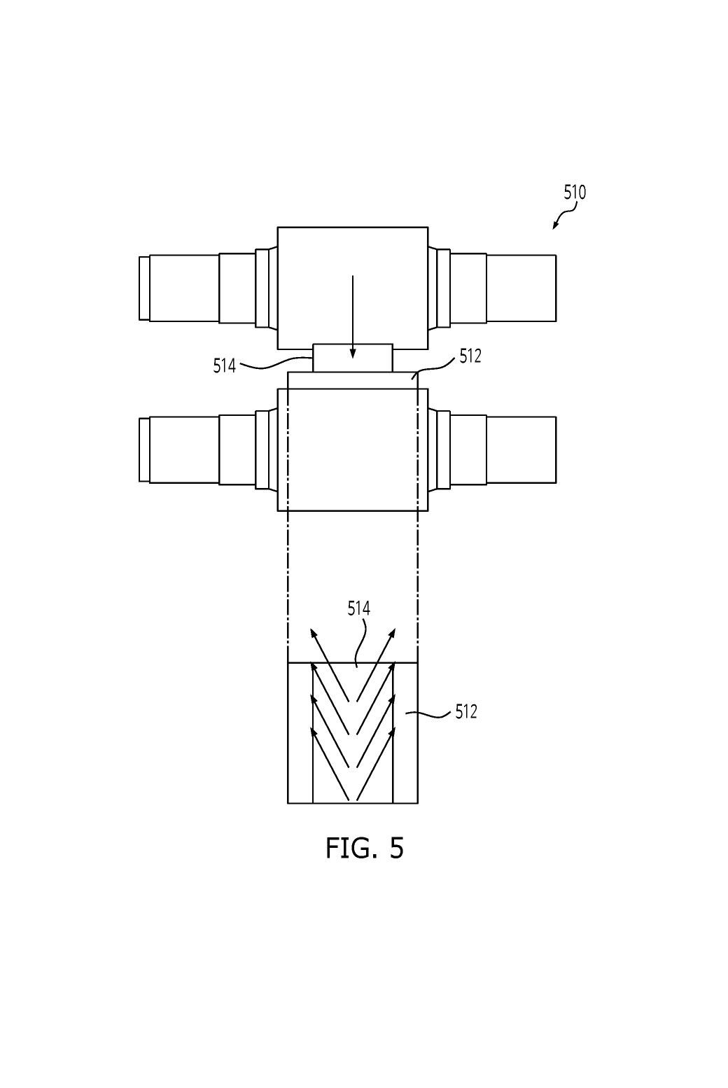

FIG. 5 is a schematic view of a rolling process of manufacturing an electrode plate provided to a deviation correction system according to some embodiments of the present disclosure.

Referring to FIG. 5, a roller 510 for performing a rolling process may pressurize an electrode plate including a current collector 512 and an active material layer 514 to make the electrode plate have a uniform thickness. In some embodiments, the roller 510 may carry out a roll pressing process including passing an electrode plate between a plurality of rollers to produce an electrode plate of a uniform thickness. In some embodiments, the rollers may have been heated to a temperature ranging from 60 °C to 220 °C.

The roller 510 may press an electrode plate including the current collector 512 and the active material layer 514 so that a binder included in the active material layer 514 may be coupled to the current collector 512.

During the rolling process, the roller 510 may apply a strong pressure to the electrode plate using a roller, or another similar device, so that the active material layer 514 and the current collector 512 may be coupled to each other. In this process, a difference in stress may occur between a coated portion (having both the active material layer 514 and the current collector 512) and a non-coated portion (not having the active material layer 514). The coated portion may be thicker, so it may receive a stronger pressure than the non-coated portion. As a result, the coated portion may be stretched more than the non-coated portion.

The resulting difference in elongation may later cause a deviation that the electrode plate, which has been cut in a direction in which it moves, is bent during a half-slitting process of severing the electrode plate in half. In some embodiments, after the half-slitting process is performed, the electrode plate may be divided into a first electrode plate and a second electrode plate, and a deviation may occur on each of the first electrode plate and the second electrode plate in opposite directions.

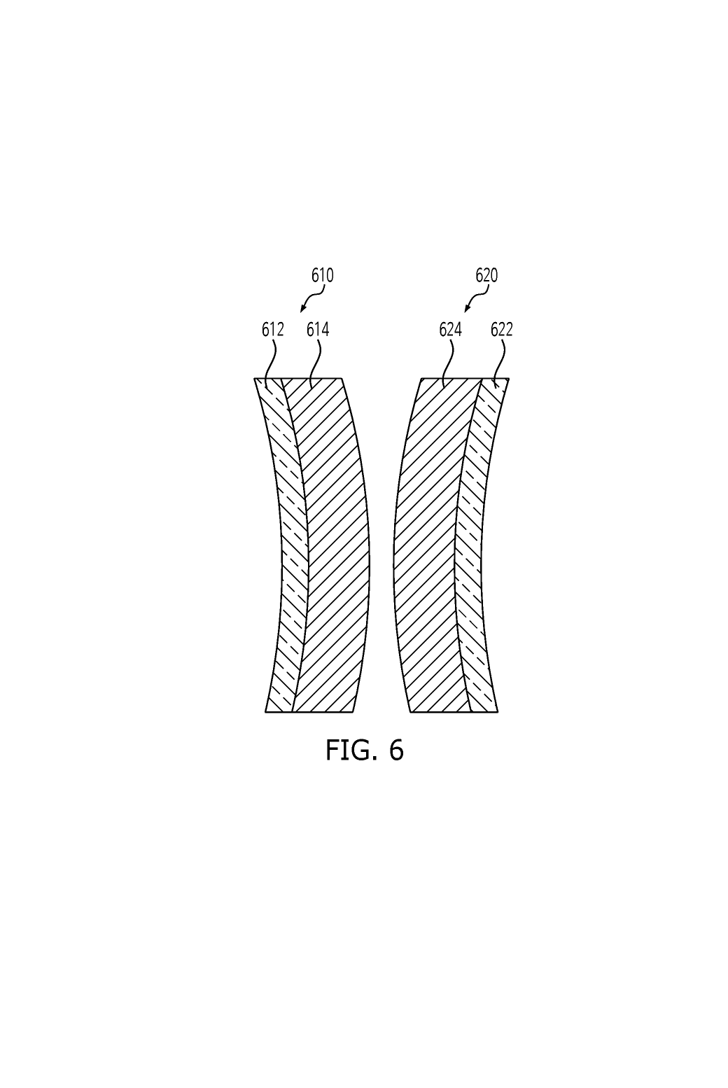

FIG. 6 shows an electrode plate that has passed through a half-slitter of a deviation correction system according to some embodiments of the present disclosure.

Referring to FIG. 6, after a half-slitting process is performed by the half-slitter of the deviation correction system according to some embodiments, the electrode plate may be severed parallel to a direction in which it moves. As a result, a single electrode plate may be separated into a first electrode plate 610 and a second electrode plate 620.

The first electrode plate 610 may include a first current collector 612 and a first active material layer 614, and the second electrode plate 620 may include a second current collector 622 and a second active material layer 624. The first current collector 612 and the second current collector 622 may be formed of the same material. Similarly, the first active material layer 614 and the second active material layer 624 may be formed of the same material.

A deviation may occur on each of the first and second electrode plates in opposite directions. In some embodiments, the deviation may occur as the coated portion becomes longer than a non-coated portion because a coated portion may be more stretched during a rolling process due to having both the active material layer 614 and 624 and the current collector 612 and 622. As a result, as shown in FIG. 6, the deviation may occur on the left of the first electrode plate 610 (the first electrode plate having the coated portion on the right), and the deviation may occur on the right of the second electrode plate 620 (the second electrode plate having the coated portion on the left).

FIG. 7 is a plan view of a deviation correction system according to some embodiments of the present disclosure.

Referring to FIG. 7, a spiral roller of the deviation correction system according to some embodiments of the present disclosure may include a first spiral roller 732 and a second spiral roller 734. A protrusion of the first spiral roller 732 and a protrusion of the second spiral roller 734 may be formed in opposite directions. For example, when viewed from one side, the protrusion of the first spiral roller 732 may be spirally wound around the first spiral roller 732 in a counterclockwise direction while the protrusion of the second spiral roller 734 may be spirally wound around the second spiral roller 734 in a clockwise direction. A direction of the protrusion of the first spiral roller 732 and a direction of the protrusion of the second spiral roller 734 are not limited to directions described above and may include various directions.

The deviation correction system may include a half-slitter 710 that cuts an electrode plate 700 in a direction in which the electrode plate 700 moves. In FIG. 7, the electrode plate 700 may move from the bottom to the top of the drawing. The electrode plate 700 may be cut parallel to the direction in which it moves by the half-slitter 710 and may be separated into a first electrode plate 702 and a second electrode plate 704.

The first electrode plate 702 and the second electrode plate 704 may be heated to a temperature ranging from 80 °C to 250 °C by a heater 720 before being inserted between the spiral roller 732 and the spiral roller 734 respectively and a base roller. A deviation on the first electrode plate 702, which has become more flexible by being heated, may be corrected by the first spiral roller 732 and a first base roller (not shown) facing and spaced apart from the first spiral roller 732. Similarly, a deviation on the second electrode plate 704, which has become more flexible by being heated, may be corrected by the second spiral roller 734 and a second base roller (not shown) facing and spaced apart from the second spiral roller 734.

The deviation correction system may further include an additional sensor for checking whether deviations of the first electrode plate 702 and the second electrode plate 704 have been corrected. The additional sensor may be placed after the first spiral roller 732 and the second spiral roller 734 in the direction in which the electrode plate 700 moves.

The additional sensor may include a vision sensor or a thickness sensor. The vision sensor may monitor a change in the condition of the electrode plate 700 and inspect the size, twist, etc. of the electrode plate 700 by using a camera and software for processing images. The thickness sensor may measure the thickness of the first electrode plate 702 and the thickness of the second electrode plate 704 in real time in order to determine whether the thickness of the first electrode plate 702 and the thickness of the second electrode plate 704 remain uniform even after the process of correcting deviations thereof. For example, the thickness sensor may include a laser thickness sensor, an ultrasonic thickness sensor, an optical thickness sensor, or any combination thereof.

The deviation correction system may further include a center position control (CPC) that aligns the relative position of the first electrode plate 702 provided to the first spiral roller 732 with the first spiral roller 732. In some embodiments, the deviation correction system may further include a CPC that aligns the relative position of the second electrode plate 704 provided to the second spiral roller 734 with the second spiral roller 734.

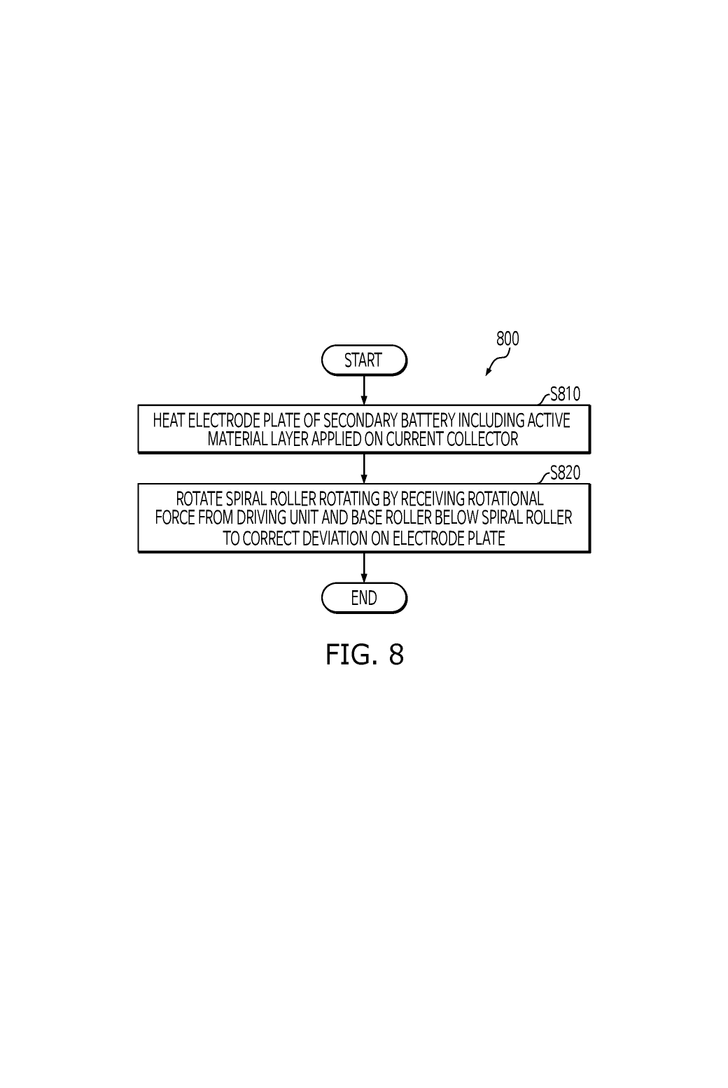

FIG. 8 is a flowchart of a method of correcting a deviation according to some embodiments of the present disclosure.

A method 800 of correcting a deviation may begin with heating an electrode plate of a secondary battery including an active material layer applied on a current collector S810. In some embodiments, a heater may include an NIR lamp.

A spiral roller (including a spiral protrusion) and a base roller (facing and spaced apart from the spiral roller) may be rotated to correct a deviation on the electrode plate moving between the spiral roller and the base roller S820.

The spiral roller may receive a rotational force from a driver, and a clutch may be arranged between the driver and the spiral roller to send the rotational force to the spiral roller. In some embodiments, the clutch may include a powder clutch. In some embodiments, the driver may be controlled by a controller receiving a signal from a deviation sensing sensor, which measures the level of deviation of the electrode plate.

The rotation of the base roller may be linked to the rotation of a rewinding roller that winds the electrode plate. In some embodiments, a direction in which the spiral protrusion of the spiral roller advances may be perpendicular to a direction in which the electrode plate moves.

The spiral protrusion of the spiral roller may include a coating layer, and the coating layer may have a thickness ranging from 40 μm to 60 μm. In some embodiments, the coating layer may include EPDM. A height of the protrusion may be from 1.5 mm to 2.5 mm, and a width of the protrusion may be from 10 mm to 14 mm. A distance between protrusions of the spiral protrusion, spaced apart from each other in the axial direction of the spiral roller, may be from 8 mm to 12 mm.

In some embodiments, correcting of the deviation of the electrode plate S820 may include correcting of a first electrode plate and a second electrode plate in opposite directions.

The method 800 may further include severing of the electrode plate in the direction in which the plate moves by a half-slitter before heating the plate of the secondary battery including the active material layer applied on the current collector S810.

In some embodiments, the electrode plate may include the first electrode plate and the second electrode plate, the spiral roller may include a first spiral roller and a second spiral roller, and the protrusion of the first spiral roller and the protrusion of the second spiral roller may be formed in opposite directions.

The method 800 may further include receiving a signal from the deviation sensing sensor and controlling the driver providing a rotational force to the spiral roller. The rotation of the spiral roller and the rotation of the base roller may have different torques.

In some embodiments, a secondary battery whose deviation is corrected may include a lithium battery cell, a sodium battery cell, etc. However, the present disclosure is not limited thereto, and examples of the secondary battery may include all batteries that can repeatedly provide electricity by charging and discharging. In some embodiments, the secondary battery can be applied to automobiles, mobile phones, or various electrical devices, but the present disclosure is not limited thereto.

In some embodiments, through a deviation correction apparatus, it may be possible to minimize deviations caused by a difference in stress occurring in a rolling process and to lower a cell defect rate in a process of winding or stacking electrodes.

Although the present disclosure has been described above with respect to embodiments thereof, the present disclosure is not limited thereto. Various modifications and variations can be made thereto by those skilled in the art.

What is claimed is:

1. A deviation correction apparatus, the apparatus comprising:
a heater configured to heat an electrode plate of a secondary battery having an active material layer on a current collector;
a spiral roller having a spiral protrusion; and
a base roller facing and spaced apart from the spiral roller,
wherein the spiral roller and the base roller are configured so that the electrode plate is inserted between the spiral roller and the base roller and is moved between the spiral roller and the base roller.

2. The deviation correction apparatus as claimed in claim 1, further comprising a half-slitter configured to sever the electrode plate in a direction in which the plate moves.

3. The deviation correction apparatus as claimed in claim 1, wherein the spiral roller is configured such that a traveling direction of the spiral protrusion of the spiral roller is perpendicular to a moving direction of the electrode plate.

4. The deviation correction apparatus as claimed in claim 3, wherein a height of the spiral protrusion is from 1.5 mm to 2.5 mm, and a width of the spiral protrusion is from 10 mm to 14 mm.

5. The deviation correction apparatus as claimed in claim 3, wherein the spiral protrusion includes protrusions spaced apart from each other in an axial direction, and a distance between the protrusions spaced apart from each other in the axial direction is from 8 mm to 12 mm.

6. The deviation correction apparatus as claimed in claim 3, wherein the spiral protrusion includes a coating layer, and a thickness of the coating layer is from 40 µm to 60 µm.

7. The deviation correction apparatus as claimed in claim 3, wherein the spiral protrusion includes a coating layer, and the coating layer includes ethylene-propylene diene monomer (EPDM).

8. The deviation correction apparatus as claimed in claim 1, wherein the spiral roller includes a first spiral roller and a second spiral roller, and a protrusion of the first spiral roller and a protrusion of the second spiral roller are configured to advance in opposite directions.

9. The deviation correction apparatus as claimed in claim 1, further comprising:
a driver configured to provide a rotational force to the spiral roller; and
a clutch configured to send the rotational force provided by the driver to the spiral roller.

10. The deviation correction apparatus as claimed in claim 9, wherein the clutch includes a powder clutch.

11. The deviation correction apparatus as claimed in claim 1, wherein the heater includes a near-infrared (NIR) lamp.

12. The deviation correction apparatus as claimed in claim 1, further comprising:
a driver configured to provide a rotational force to the spiral roller;
a deviation sensing sensor configured to measure a level of deviation of the electrode plate; and
a controller configured to receive a signal from the deviation sensing sensor and configured to control the driver.

13. The deviation correction apparatus as claimed in claim 1, further comprising a rewinding roller configured to wind the electrode plate.

14. The deviation correction apparatus as claimed in claim 13, wherein a rotation of the base roller is linked to a rotation of the rewinding roller.

15. The deviation correction apparatus as claimed in claim 1, wherein a rotation of the spiral roller has a torque different than the torque of a rotation of the base roller.

16. A method of correcting a deviation, the method comprising:
heating an electrode plate of a secondary battery having an active material layer on a current collector;
inserting an electrode plate between a spiral roller having a spiral protrusion and a base roller facing and spaced apart from the spiral roller;
moving the electrode plate between the spiral roller and the base roller; and
rotating the spiral roller and the base roller to correct a deviation of the electrode plate.

17. The method of correcting a deviation as claimed in claim 16, further comprising severing the electrode plate in a direction in which the electrode plate moves by a half-slitter before heating the electrode plate of the secondary battery.

18. The method of correcting a deviation as claimed in claim 16, wherein the electrode plate includes a first electrode plate and a second electrode plate, the spiral roller includes a first spiral roller and a second spiral roller, and a protrusion of the first spiral roller and a protrusion of the second spiral roller advance in opposite directions,
the method further comprising correcting the first electrode plate and the second electrode plate in opposite directions.

19. The method of correcting a deviation as claimed in claim 16, further comprising controlling, via a controller, a driver so that the driver provides a rotational force to the spiral roller when the controller receives a signal from a deviation sensing sensor.

20. The method of correcting a deviation as claimed in claim 16, wherein a rotation of the base roller is linked to a rotation of a rewinding roller winding the electrode plate, and
wherein the method further comprises winding the electrode plate via the rewinding roller.
